(19) United States
(12) Patent Application Publication
(10) Pub. No.: US 2024/0034567 A1
(43) Pub. Date: Feb. 1, 2024

(54) ANGLED TRANSFER WITH ROLLER CHAIN

(71) Applicant: Peter DUECKER, Lagenfeld (DE)

(72) Inventor: Peter DUECKER, Lagenfeld (DE)

(21) Appl. No.: 18/032,225

(22) PCT Filed: Nov. 11, 2021
(86) PCT No.: PCT/EP2021/081369

§ 371 Date: Apr. 17, 2023

(30) Foreign Application Priority Data
Nov. 12, 2020 (DE) 10 2020 129 833.1

(51) Int. Cl. B65G 17/08; B65G 17/24

(52) U.S. Cl. CPC B65G 17/08; B65G 17/24

(57) ABSTRACT

The invention relates to a conveyor having a driven roller chain and a driveable drive face oriented transversely thereto, wherein, in one conveying direction, the rollers of the roller chain run transversely to the underlying drive face, which means that the rollers do not roll thereon but are only pulled thereover, and only when the conveyed goods are to be moved transversely to said conveying direction is the drive of the roller chain switched off and the drive of the drive face switched on, this having the effect that the rollers then rotate in the rotational direction of their longitudinal axis and move the conveyed goods transversely to the previous conveying direction, so that surprisingly friction of the rollers during their movement over the stationary drive face is permitted when the conveyed goods are moved in one conveying direction, and then, when said goods are to be rotated, the drive face is moved and the drive of the roller chain is switched off so that the drive face then causes the rollers to rotate and thus the conveyed goods to move.

The invention relates to a conveying apparatus with a roller conveyor.

From DE 602 22 080 [U.S. Pat. No. 6,986,420] from Lam LLC with the designation “Divided modules in modular conveyor belts,” for example, such a conveying apparatus is known in the prior art, whose balls or rollers always run over the drive surface, that is to say they roll on it. If rotation, for example by 90° of the stack (generally conveyed material) is to take place, the one conveyor belt must be lifted for this change in the travel direction and a conveyor belt aligned transversely thereto must be activated. In any case, the running direction, in particular of the rollers, that is to say its longitudinal axis, is always parallel to the travel direction.

The object of the invention is to simplify the construction of the conveying apparatus while movement sequences of the conveyed material remain the same.

This object of the invention is achieved by the features of claim 1.

The invention now uses the following effect that the conveying apparatus is designed accordingly: a longitudinal travel direction extends such that the rollers of the roller chains run transversely with respect to the driving surface lying underneath. This means that the rollers do not roll there but are only pulled over it. Only when the material to be conveyed is to be moved transversely to this travel direction is the drive of the roller chains switched off and the drive of the drive surface switched on. This has the effect that the rollers now rotate in the direction of rotation of their longitudinal axis and move the material to be conveyed transversely to the previous travel direction. Surprisingly, friction of the rollers during its movement over the stationary drive surface is permitted when the material to be conveyed is moved in one travel direction. When they are to be rotated, the drive surface is moved and the drive of the roller conveyor is switched off so that the drive surface now rotates the rollers and thus moves the conveyed material.

In a further development of the invention, it is provided that there is only one driven roller conveyor and two drive surfaces oriented transversely thereto and driven independently of each other. As a result, the construction of the conveying apparatus is simplified, and it is possible at the same time to rotate the material to be conveyed at any desired angle by targeted counter rotation of the two drive surfaces.

In a development of the invention, it is provided that is the at least one drive is an electric motor and acts on a deflection roller of the conveying apparatus directly or with the interposition of a transmission. Robust drives are thus available that can be controlled very simply and very sensitively to move the conveyed material.

In a development of the invention, it is provided that the drive surface is a belt. In the field of conveying technology, there is a multiplicity of robust belts (bands) that can be selected for the purpose of application of the conveying apparatus and depending on the type of material to be conveyed.

In a further development of the invention, it is provided that the drive surface is a plastic chain comprising a plurality of chain links arrayed next to one another and movably connected to one another. In this way, a special embodiment of the drive surface is available, which in practice has proven very well in practice in the past. This roller conveyor is arranged on a shaft or the roller has in each case one shaft end on the end face, and the ends of the shaft or the two shaft ends are mounted in the conveyor member.

A possible embodiment of the conveying device and its operation or functional sequences are described below with reference to the drawing.

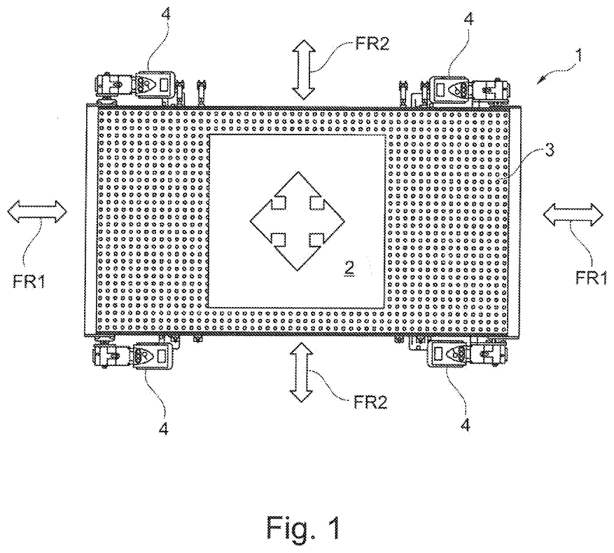

FIG. 1 shows an embodiment of a conveying device 1 for moving a conveyed item 2. The conveyed material 2 rests on a roller conveyor 3 with rollers. The roller conveyor 3 is driven by at least one drive 4. The conveying device 1 can displace the conveyed material 2 in a first longitudinal travel direction FR1 and a second transverse travel direction FR2 oriented transversely thereto.

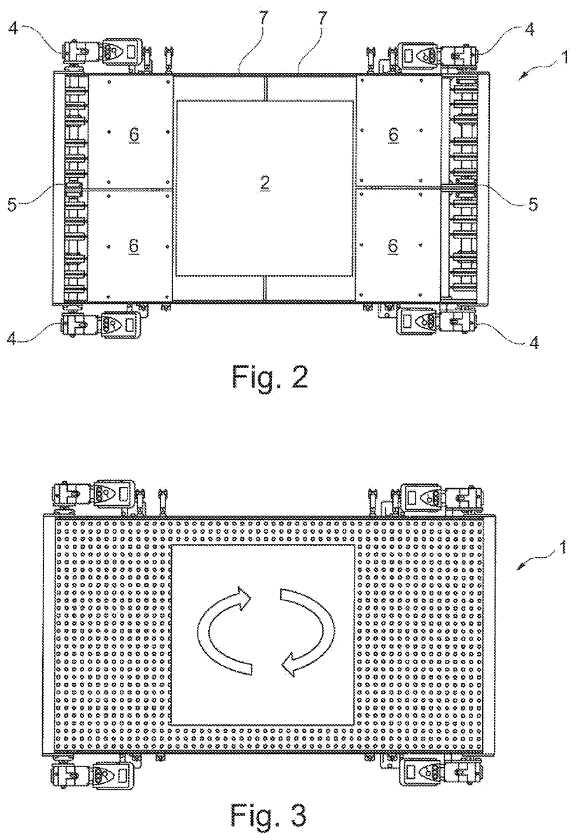

FIG. 2 shows the embodiment of the conveying device 1 according to FIG. 1 without the roller conveyor 3. As a result, deflection rollers 5 are shown around which the roller conveyor 3 runs as an endless chain. In this embodiment, a separate drive (for example an electric motor with transmission, in particular a reduction gear) is provided at the ends of the deflection rollers 5, and support surfaces 6 for supporting the roller conveyor 3 are also provided on which the roller conveyor 3 rests when stationary or moving. Two bearing surfaces 6 are shown for each deflection roller 5. At each deflection roller 5, more than two bearing surfaces 6 (simplified the exchange of worn surface elements) or also only one bearing surface 6 (simplified assembly) can also be present.

At least one drive surface 7 is arranged between the deflection rollers 5 and their associated bearing surfaces 6. FIG. 2 shows two drive surfaces 7 arranged parallel to one another. These surfaces are controlled and moved in a targeted manner in order to control the movement of the conveyed material 2 with drives (not shown). ?The surface of the at least one drive surface 7 lies approximately, preferably exactly, in a plane facing the underside of the conveyed material 2, in which the surface of the support surfaces 6 is also located.

It is important to note that for a better understanding FIG. 2 does not show the roller conveyor 3, but in practice it is present. Consequently, the under side of the conveyed material 2 rests on the upper side of the roller conveyor 3, and not (as in FIG. 2 the impression could arise) on the upper side of the drive surface 7.

FIG. 3 shows that the conveyed goods 2 can be moved in any direction by targeted control of the drives of the roller conveyor 3 and of the at least one drive surface 7 and can also be rotated.

Function Sequence:

According to FIG. 1, the conveyed material 2 (in particular the stack) can be conveyed from all sides onto the conveying apparatus 1 (so-called angular transfer with a roller conveyor) and can be conveyed either straight through or angled off through 90°.

Under the roller conveyor 3 there is a drive surface 7 (plastic chain) that, together with the roller conveyor 3, enables movement through 90° (FIG. 2).

In addition, by driving the chains in opposite directions, it is possible to rotate the stack at the location at any angle (FIG. 3),

The drawing shows that the two travel directions FR1 and FR2 are oriented at right angles to one another. These are preferred travel directions to which the application of the invention is not limited. Depending on the connection and/or disconnection or interaction of the drives, the conveyed material 2 can also be anguled (as shown and described in FIG. 3) or offset obliquely with respect to the travel direction FR1 or FR2.

In this context, the term “rollers” is understood here to mean not only cylindrical elements, but also balls. Preferably, however, cylindrical elements come into consideration when the conveyed goods are cardboard sheets, since such a cylindrical element for the underside of the cardboard sheet, in particular the lowermost cardboard sheet of a stack of cardboard panels, has apex regions that form a larger bearing surface. In this case, a point-shaped apex of a sphere would disadvantageously press into the cardboard sheet and thus damage it and make it more difficult to transport by the conveying apparatus. However, if the material of the conveyed material is more resistant to these pressing forces, spherical elements are also suitable

A conveying apparatus with a driven roller conveyor and a drivable drive surface oriented transversely thereto, where in one travel direction the rollers of the roller chains run transversely with respect to the drive surface lying underneath so that these rollers do not roll there, but are only pulled over it, and only when the conveyed material is to be moved transversely to this travel direction is the drive of the roller chains switched off and the drive of the drive surface is switched on. This has the effect that the rollers now rotate in the direction of rotation of their longitudinal axis and move the material to be conveyed transversely to the previous travel direction, so that, in a surprising manner, friction of the rollers is permitted during its movement over the stationary drive surface when the material to be conveyed is moved in the one travel direction, wherein when the conveying material is to be rotated, the drive surface is moved and the drive of the roller keys is switched off so that the drive surface now rotates the rollers and thus brings about the movement of the conveyed material.

### LIST OF REFERENCE SIGNS

1 Conveying apparatus
2 Material to be conveyed
3 Roller conveyor
4 Drive (if necessary with transmission)
5 Deflection roller
6 Support surface
7 Drive surface
FR1 first travel direction
FR2 further travel direction

1. A conveying apparatus for moving a material to be conveyed, the conveying apparatus comprising:
at least one roller conveyor driven by at least one drive and having a plurality of rollers arranged transversely and one behind the other;
at least one drivable drive surface oriented transversely to the roller conveyor, the rollers of the roller conveyor running transversely to the driving surface and lying underneath in one conveying direction; and
means connected to the roller conveyor for operating it so that the rollers do not roll on the drive surface but are only pulled over it, and only when moving the conveyed material transversely to this conveying direction is the drive of the roller conveyor and the drive of the drive surface switched on so that the rollers now rotate in the direction of rotation of their longitudinal axis and move the conveyed material transversely to the previous conveying direction in a conveying direction.

2. The conveying apparatus for moving a material to be conveyed according to claim 1, wherein there is only one driven roller conveyor and two drive surfaces oriented transversely thereto and drivable independently of each other.

3. The conveying apparatus for moving a material to be conveyed according to claim 1, wherein the drive is an electric motor and acts on a deflection roller of the conveying apparatus directly or with the interposition of a transmission.

4. The conveying apparatus for moving a material to be conveyed according to claim 1, wherein the drive surface is a belt.

5. The conveying apparatus for moving a material to be conveyed according to claim 1, wherein the drive surface is a plastic chain comprising a plurality of chain links arranged side by side and one behind the other and movably connected to one another.

6. The conveying apparatus for moving a material to be conveyed according to claim 1, wherein the roller conveyor consists of a plastic chain of a plurality of chain links arranged next to one another and in a movable manner and are movably connected to one another, each chain link having a recess and a roller therein, the rollers being on a shaft whose ends are supported in the conveyor member.

7. The conveying apparatus for moving a material to be conveyed according to claim 1, wherein the roller conveyors consist of a plastic chain consisting of a plurality of chain links arranged next to one another and in a movable manner and movably connected to one another, each conveyor element having a recess and a roller therein, the roller having a shaft end at each end and the two shaft ends being mounted in the chain link.
